(19) United States
(12) Patent Application Publication
(10) Pub. No.: US 2009/0066078 A1
(43) Pub. Date: Mar. 12, 2009

(54) Close-Coupled Fitting

(76) Inventor: Peter Robert Morley, Victoria (AU)

Correspondence Address: Peter Morley;Gregg Bach, 2221 Panama Street, Philadelphia, PA, 19103, US

(21) Appl. No.: 11/718,602

(22) PCT Filed: Nov. 8, 2005
(86) PCT No.: PCT/AU05/01695

§ 371 Date: May 3, 2007

(30) Foreign Application Priority Data
Nov. 12, 2004 (AU) 2004100959

(51) Int. Cl. F16L 41/02; F16L 41/03

(52) U.S. Cl. 285/122.1; 285/132.1

(57) ABSTRACT

The close-coupled fitting allows practical vessel/s to be connected in a manifold configuration with minimal space between them. As an example, a Tee-piece close-coupled fitting is in the shape of a “T” and comprises a fitting at an approximate 90° angle extending from the 180° plane. One end of the section on the 180° plane is a female socket that begins approximately flush with one side of the 90° fitting and has an internal limit that intrudes some-way into the opening of the 90° fitting. The male socket of the 180° plane extends outwards from the other side of the 90° fitting. Multiple Tee-piece close-coupled fittings connect along the 180° plane by inserting the male socket into the female socket. This invention allows an alternative manner of manufacture for storage units that affords flexibility and maximises the available space for such units.

### BACKGROUND TO THE INVENTION

The current state of water supply in Australia demands alternative approaches to domestic protocols—most importantly water-saving devices. Rainwater storage will become increasingly important, yet application of existing systems is restricted. Existing rainwater storage systems are limited in their design, which in turn limits their potential location within any given environment. This invention addresses those limitations by enabling close-coupling of any practical vessel, particularly, but not limited to, cylindrical vessels, thereby maximising existing space availability and allowing application of water-saving devices where they were previously excluded because of a lack of practical alternatives to the current design limitations on these products.

A close-coupled fitting in accordance with this innovation may take a variety of forms, but we will continue this description using a Tee-piece as our model embodiment. Currently, connecting multiple Tee-pieces on the 180° plane requires a male and female socket on each fitting in order to connect pipes/conduits/tubes or any practical vessel on the 90° angle from the 180° plane. However, the 90° angle fittings are still separated by a relatively large distance required by the connection of the male/female coupling on the 180° plane. The close-coupled fitting removes that distance required for the male/female couple and enables these Tee-piece fittings to connect with minimal space required between the fittings on the 90° angle from the 180° plane. The close-coupled fitting is equally applicable to other connecting pieces such as cross-angles, elbows and bends. Furthermore, this invention is not limited to water-saving devices, but is applicable to any liquid or gaseous product that requires storage where storage space is limited.

### OBJECT OF THE INVENTION

It is an object of the invention to provide a means for coupling any practical vessel in close spatial arrangement, thereby ameliorating existing fitting problems and having all of the advantages of the prior art and novel features that result in a new fitting that is not anticipated, rendered obvious, suggested or even implied by any of the prior art in this field. Another object of the invention is to provide consumers with a choice.

### DETAILED DESCRIPTION OF THE INVENTION

The various features of novelty that characterise the invention are noted and described in the claims of this disclosure. For a better understanding of the invention refer to the accompanying drawings and descriptive matter of the preferred embodiments of the invention given herein. As an example, the invention may be better understood with reference to the illustrations of a Tee-piece embodiment of the invention, which are:

FIG. 1 is an elevation of the top view of a close-coupled fitting looking through the 180° plane.

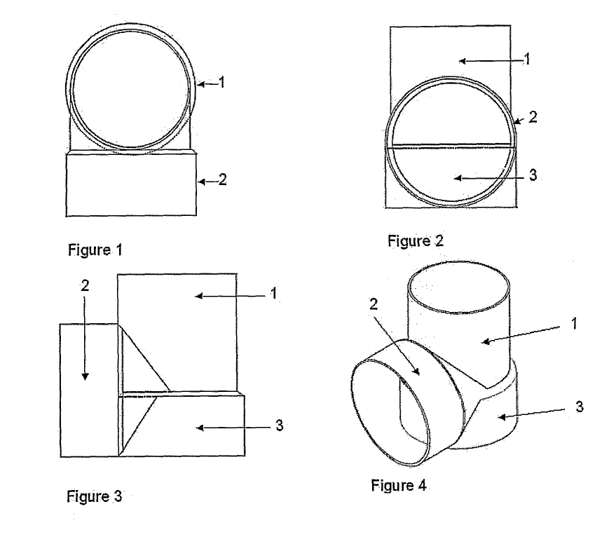

FIG. 2 is an elevation of the side view of a close-coupled fitting looking into the 90° fitting section with the female socket intruding on the 180° plane.

FIG. 3 is an elevation of the close-coupled fitting from the side. The vertical fitting is the 180° plane and the 90° fitting is horizontal.

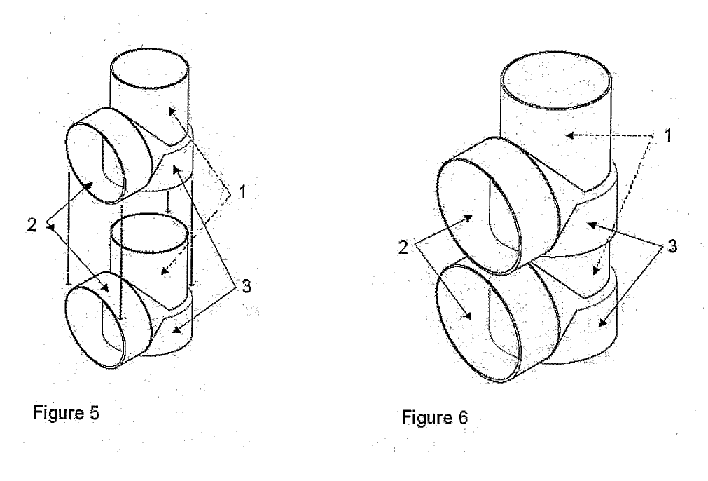

FIG. 4 is an isometric view of the close-coupled fitting. The vertical fitting is the 180° plane and the 90° fitting is horizontal.

FIG. 5 a three-dimensional elevation showing the male and female sections on the 180° plane about to connect the 90° fittings in close spatial arrangement.

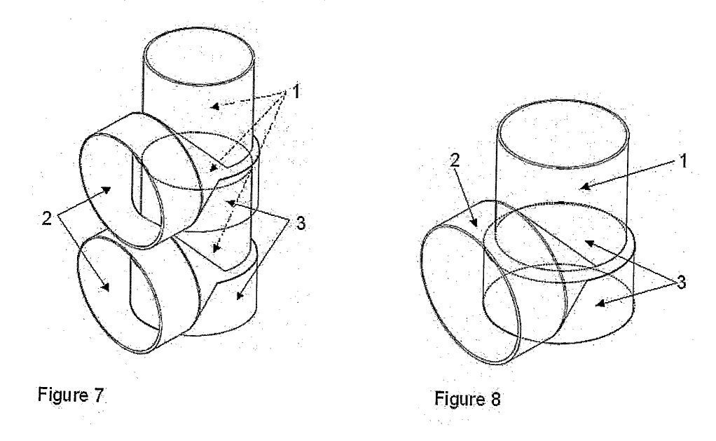

FIG. 6 a three-dimensional elevation showing the connected Tee-pieces with the 90° fittings in close spatial arrangement.

FIG. 7 shows via the dotted lines a view of the male end of the fitting coupled into the female end of another fitting.

FIG. 8 is a transparency of the female socket intruding into the opening of the fitting on the 90° angle.

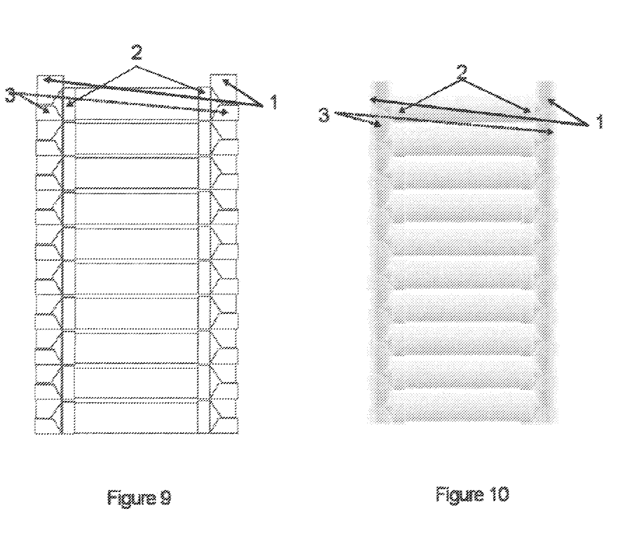

FIGS. 9 and 10 show one method of connecting multiple Tee-piece close-coupled fittings with pipes or conduits.

FIG. 11 is a 3-dimensional elevation of the close-coupled fitting from the side, as in FIG. 3.

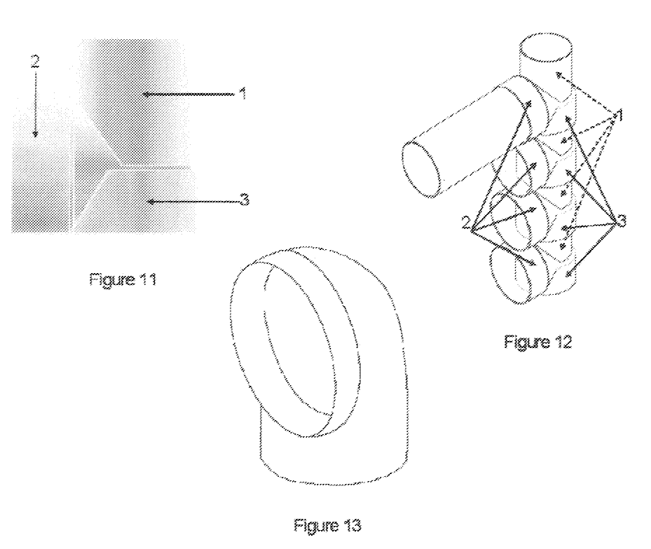

FIG. 12 shows connected fittings with a pipe fitted in the 90° angle fitting.

FIG. 13 is an elbow- or bend-shaped embodiment of the close-coupled fitting.

### SUMMARY OF THE INVENTION

In essence, a close-coupled fitting is a fitting that allows two or more pipes/conduits/tubes or any practical vessel to be connected in a manifold configuration with minimal space between them. As an example embodiment, a Tee-piece close-coupled fitting is in the shape of a “T” and comprises a fitting at an approximately 90° angle (2) extending from the 180° plane. One end of the section on the 180° plane is a female socket that begins approximately flush with one side of the 90° fitting and has an internal limit that intrudes some-way into the opening of the 90° fitting (3). The male socket of the 180° plane extends outwards from the other side of the 90° fitting (1) as in FIGS. 1 to 12. Multiple Tee-piece close-coupled fittings connect along the 180° plane by inserting the male socket (1) into the female socket (3) as in FIGS. 5, 6, 7 and 12. Multiple Tee-piece close-coupled fittings may be used to arrange pipes/conduits/tubes or any practical vessel in close spatial arrangement by attaching the assembled multiple Tee-pieces to both ends of the pipes/conduits/tubes or any practical vessel as in FIGS. 9 and 10. This invention enables consumers and/or manufacturers to take advantage of the inherent strength of connecting multiple, practical vessels against inward or outward pressures not afforded by larger vessels of the same shape. Thus, the need for any bracing or reinforcing that would be necessary in any existing storage facility is removed along with limitations to height and width, thereby allowing much greater flexibility for consumers, particularly flexibility in potential location of storage facilities manufactured using this invention.

The claims defining the invention are as follows:

1. A fitting that provides inherent strength for the connection of conduits in a closely coupled configuration designated to have a contiguous flow comprising a female socket at one end of the flow-through section of the fitting that intrudes into the inner section of an intersecting socket thereby partially obstructing said intersecting socket and removing any influence of a female socket that extends externally on the coupling proximity of conduits, and with the opposing end of the flow-through section of the fitting being a male socket.

2. A close-coupled fitting according to any claims 1 that is manufactured to have more than one intersecting socket.

3. A close-coupled fitting according to any claims 1 or 2 wherein the close-coupled fitting is made of any material suitable to the application.

4. A close-coupled fitting according to any previous claim wherein the close-coupled fitting is any practical size and/or shape or a combination of sizes and shapes suitable to the application.

5. A close-coupled fitting substantially as herein before described with reference to FIGS. 1-8 and 12 of the accompanying drawings.
